(19) United States
(12) Patent Application Publication
(10) Pub. No.: US 2020/0068403 A1
(43) Pub. Date: Feb. 27, 2020

(54) METHOD FOR SECURE UPDATING OF A STATIC STATE DISPLAY BY AN UPDATING DEVICE AND SYSTEM COMPRISING THE STATIC STATE DISPLAY AND THE UPDATING DEVICE

(71) Applicant: Sony Mobile Communications Inc., Tokyo (JP)

(72) Inventors: Jari SASSI, Lund (SE); Lars THERN, Lund (SE); Martin TÖRNQVIST, Lund (SE)

(21) Appl. No.: 16/461,642

(22) PCT Filed: Oct. 13, 2017
(86) PCT No.: PCT/IB2017/056359

§ 371 Date: May 16, 2019

(30) Foreign Application Priority Data
Nov. 24, 2016 (EP) 16200448.5

(51) Int. Cl. H04W 12/06; H04W 4/80; G09G 3/34; H04L 29/06; H04W 12/04

(52) U.S. Cl. CPC H04W 12/0608; H04W 4/80; G09G 3/3433; G09F 3/208; H04W 12/04; G09G 2358/00; H04L 63/08

(57) ABSTRACT

A method for secure updating of a static state display, the method comprising: sending (102) data from an updating device (400) to the static state display (300), wherein the data comprises a security key and update data pertaining to an update (302) to be displayed by the static state display (300); authenticating (104) the data sent by the updating device (400) at the static state display by comparing the security key with one or more reference security keys stored in a database accessible by the static state display (300); and upon successful authentication updating (106) the static state display (400) with the update (302). A system (200) comprising a static state display (300) and an updating device (400) is further provided.

### FIELD OF INVENTION

The invention relates to a method for secure updating of a static state display by an updating device and a system comprising the static state display and the updating device.

### TECHNICAL BACKGROUND

A static state display comprises at least two separate and energetically stabile states. An electrical potential is further required to switch the display from one state to the other state. In absence of an applied electrical potential the display will, however, remain in either of the two states. A pixelated static state display may therefore statically hold text and/or images indefinitely without consumption of energy. In other words, a static state display consumes energy only when the display content is updated.

Static state displays have therefore been used for electronic visual displays including electronic pricing labels in retail shops, time tables at bus stations, electronic billboards, mobile phone displays, and e-readers able to display text and/or images.

There is, however, a need for improved updating and management of the content displayed in the static state displays.

### SUMMARY OF INVENTION

It is an object of the invention to provide improved updating and management of the content displayed in the static state displays.

According to a first aspect of the invention this object has been achieved by providing a method for secure updating of a static state display by an updating device. The method comprising: sending data from an updating device to the static state display, wherein the data comprises a security key and update data pertaining to an update to be displayed by the static state display; authenticating the data sent by the updating device at the static state display by comparing the security key with one or more reference security keys stored in a database accessible by the static state display; and upon successful authentication updating the static state display with the update.

The method allows for a comparison between the security key provided by the updating device with the one or more reference security keys of the static state display. In other words, only an updating device able to transmit data comprising an authorized security key may transfer update data to the static state display. An advantage of the method thereby being that a secure updating of the content of the static state display is provided. Accidental or incorrect updating of the static state display is thereby hindered. An improved correctness of the update displayed by the static state display is further achieved.

A static state display may comprise a number of image pixels each image pixel being configured to be in a first or a second state. The static state display may therefore be referred to a pixelated static state display.

The update data may be construed as comprising information based on which an image may be formed on the static state display. The update data may comprise information pertaining to graphical and/or text elements. Thus, the update displayed on the static state display may comprise graphical and/or text elements.

The security key may be a cryptographic key, such as a digital signature. The security key may comprise biometric data, such as information associated with a fingerprint, pertaining to a user authorized to update the static state display. The security key may be a password. The password may comprise a number of letters and/or digits.

The wording authenticating may be construed as the act of validating the security key based on the one or more stored reference keys.

The static state display may be divided into a plurality of sub-regions, wherein each of the one or more reference security keys are assigned to one or more of the plurality of sub-regions, wherein the data further comprises update data pertaining to at least one of the sub-regions of the static state display.

A reduced amount of data may be sent from the updating device to the static state display. A smaller bandwidth is thereby needed for sending the data. A smaller amount of energy is, moreover, needed for updating the static state display. The division of the static state display into a plurality of sub-region allows for separate administration of different sub-regions. The method thereby allows for improved management of the update, e.g. an image content, displayed in the static state display. An update of one or more sub-regions of the static state display may thereby be allowed for a given security key. Accidental or incorrect updating of content in other sub-regions of the static state display may thereby hindered. Different users may thereby be authorized to update different sub-regions of the static state display.

The method may further comprise updating the database by

sending database updating data from a database updating device to the static state display, wherein the database updating data comprises a master key and one or more database entries;

authenticating the database updating device by comparing the master key with a reference master key stored in the database;

upon successful authentication of the database updating device updating the database with the one or more database entries.

The database entry may be construed as data comprising a reference security key and optionally one or more sub-regions of the static state display associated with the reference security key. The database entry may correspond to graphical, text and/or number elements.

The master key allows for efficient management of reference security keys stored in the database. An improved security is thereby obtained as valid security keys for updating the static state display may be brought up-to-date.

The updating device and the database updating device may be the same device or different devices.

The sending of the data may be performed by sending a single updating message comprising the security key and the update data pertaining to an update to be displayed by the static state display.

The required information for updating the static state display may thereby be sent on one session.

The sending of the data may be performed by sending a plurality of messages.

A first message of the plurality of messages may comprise the security key and wherein the update data pertaining to an update is sent as one or more messages.

A smaller amount of data may thereby be sent from the updating device to the static state display prior to the act of authorization. Less energy is thereby required. A faster authorization process may be provided. Upon successful authorization, the update data pertaining to the update may thereafter be sent in one or more messages.

The one or more messages may pertain to different sub-regions of the static state display.

The method may further comprise harvesting energy from the updating device to power the updating of the static state display.

The harvesting of energy may comprises receiving, by the static state display, electromagnetic energy transmitted by the updating device.

Energy for switching states of the static states display may thereby be provided by the updating device. The powering requirement of the static state display is reduced. The static state display may further be without a power source.

According to a second aspect of the invention a system comprising a static state display and an updating device is provided.

The updating device comprising:

a transmitter configured to send data, from the updating device to the static state display by short range communication, the data comprising a security key and update data pertaining to an update to be displayed by the static state display;

the static state display comprising:

a receiver configured to receive by short range communication data from the updating device; and

circuitry configured to:

authenticate the data sent by the updating device by comparing the security key with one or more reference security keys stored in a database accessible by the static state display; and

upon successful authentication, update the static state display with the update.

The static state display may further comprise a memory storing the database comprising one or more reference security keys.

In general, features of the second aspects of the invention provide similar advantages as discussed above in relation to the first aspect of the invention.

The system may further comprise a database updating device, the database updating device comprising:

a transmitter configured to send database updating data, from the database updating device to the static state display, the database updating data comprising a master key and one or more database entries;

wherein the receiver of the static state display is further configured to receive database updating data from the database updating device; and

wherein the circuitry of the static state display is further configured to

authenticate the updating data sent by the database updating device by comparing the master key with a reference master key stored in the database; and

upon successful authentication updating the database with the one or more database entries.

The transmitter of the database updating device may further be configured to send authorization data comprising a security key to the updating device, and

wherein the updating device further comprises:
a receiver configured to receive the authorization data from the database updating device, and
a memory storing the authorization data comprising a security key received from the database updating device.

An effective administration of valid security keys among different users or updating devices is further achieved.

The receiver of the static state display may be configured to harvest energy transmitted by the transmitter of the updating device.

The transmitter of the updating device and receiver of the static state display may be configured to communicate via short range communication.

An improved security is thereby provided as it necessitates that the receiver and transmitter are within a distance suitable for short range communication.

The short range communication may comprise INSTEON, IrDA, Wireless USB, Bluetooth, Bluetooth Low Energy, Wireless Local Area Network (WLAN) IEEE 802.x, Radio Frequency Identification (RFID), Near Field Communication (NFC), FeliCa, ANT+, Z-Wave, ZigBee, Infrared communication or ultrasound.

The updating device may be a mobile communication device.

A further scope of applicability of the present invention will become apparent from the detailed description given below. However, it should be understood that the detailed description and specific examples, while indicating preferred embodiments of the invention, are given by way of illustration only, since various changes and modifications within the scope of the invention will become apparent to those skilled in the art from this detailed description.

Hence, it is to be understood that this invention is not limited to the particular component parts of the device described or steps of the methods described as such device and method may vary. It is also to be understood that the terminology used herein is for purpose of describing particular embodiments only, and is not intended to be limiting. It must be noted that, as used in the specification and the appended claim, the articles “a,” “an,” “the,” and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings do not exclude other elements or steps.

### BRIEF DESCRIPTION OF THE DRAWINGS

The invention will by way of example be described in more detail with reference to the appended schematic drawings, which shows a presently preferred embodiment of the invention.

FIG. 1 illustrates the method for secure updating of a static state display by an updating device.

FIG. 2 illustrates a system comprising a static state display and an updating device.

FIG. 3 illustrates a system comprising a static state display and an updating device.

### DETAILED DESCRIPTION OF PREFERRED EMBODIMENTS

A static state display comprises at least two separate and energetically stabile states. An electrical potential is further required to switch the display from one state to the other state. In absence of an applied electrical potential the display will, however, remain in either of the two states. A static image may thereby be displayed. The static state display may in some cases also be referred to as a bistable display, but the static state display may in other cases comprise more than two states.

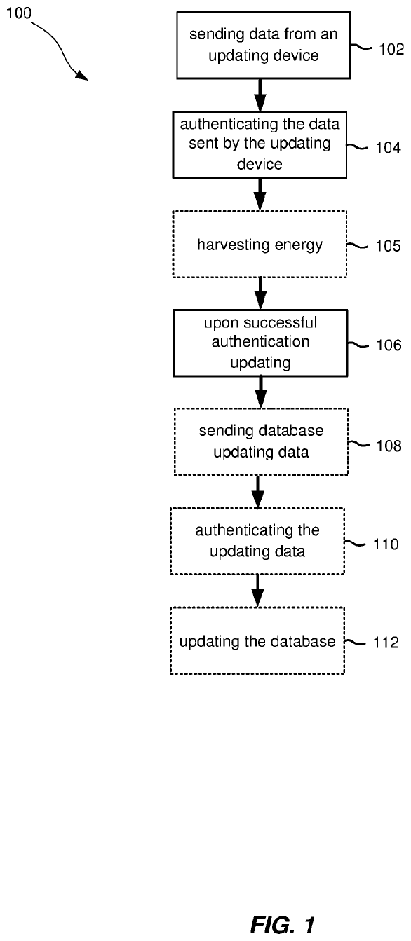

In the following a method 100 for secure updating of a static state display by an updating device will be described. Throughout the description reference will be given to FIG. 1 which illustrates the method 100.

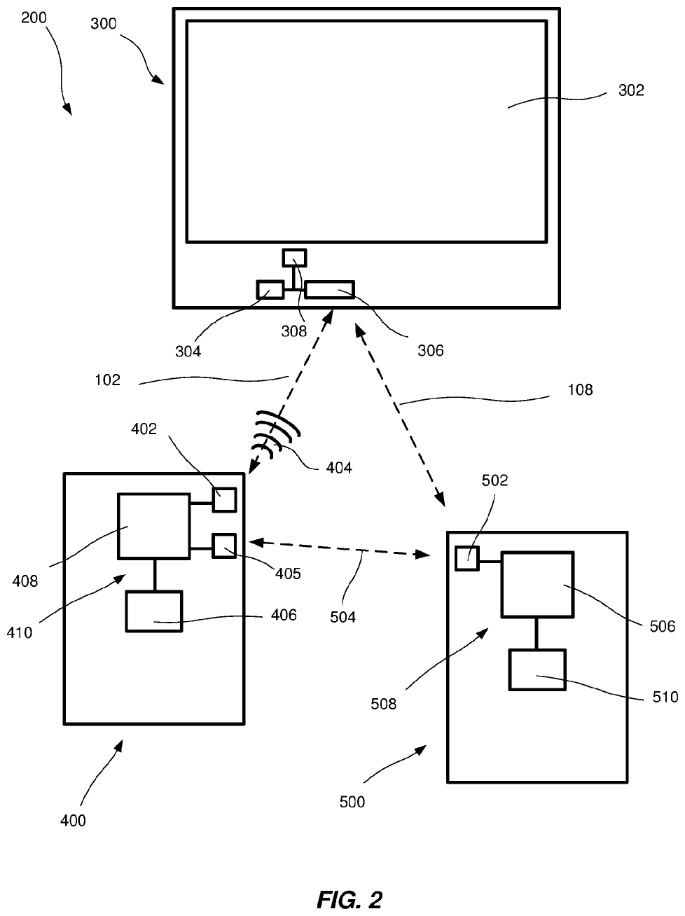

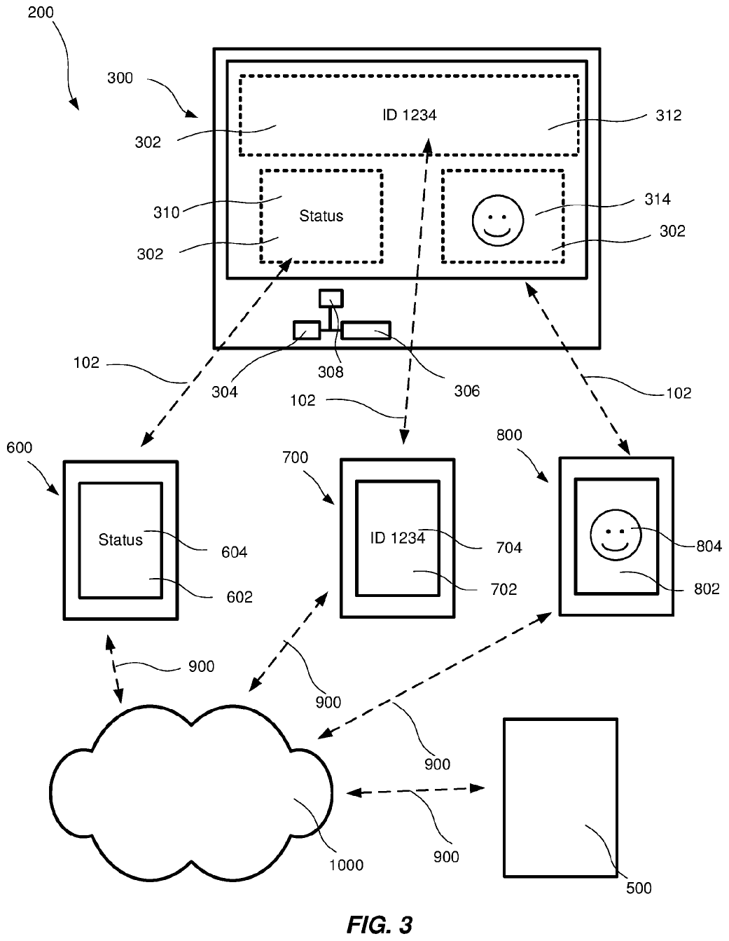

FIGS. 2 and 3 schematically illustrates a system 200 comprising the static state display 300 and the updating device 400 allowing for the updating of the static state display 300.

The updating device 400 comprises a transmitter 402 configured to send 102 data, from the updating device 400 to the static state display 300. The data comprising a security key and update data pertaining to an update 302 to be displayed by the static state display 300.

The updating device 400 may be a mobile communication device such as a mobile phone or a tablet.

The static state display 300 may comprise a memory 304 storing a database comprising one or more reference security keys. The database is thereby accessible by the static state display (300). The static state display 300 may further comprise a receiver 306 configured to receive data from the updating device 400; and circuitry 308. The circuitry 308 is configured to: authenticate the updating device 400 by comparing the security key with one or more reference security keys stored in the database; and upon successful authentication 104 of the updating device 400, update 106 the static state display 300 with the update 302.

It should be noted that a memory storing a database, comprising one or more reference security keys, may be arranged separately from the static state display provided that the database is accessible by the static state display.

The system 200 allows the static state display 300 to have a security key based authorization procedure such that only authorized users may use the updating device 400 to update 106 the static state display 300.

The static state display 300 may further comprise a processor. The processor may form part of the circuitry 308. The processor may, for example, be a microcontroller configured to handle data received by the receiver 306. The processor may further be configured to update the static state display 300 with the update 302 based on the update data received by the receiver 306.

The static state display 300 may or may not comprise a power source. The power source may be configured to switch the states of the static state display 300 such that the update 302 displayed by the static state display 300 is updated.

The method 100 may further comprise harvesting energy 105 from the updating device to power the updating of the static state display. Thus, the static state device 300 may be configured to harvest energy 404 transmitted from the updating device 400.

The receiver 306 of the static state display 300 may thereby be configured to harvest energy transmitted by the transmitter 402 of the updating device 400. For this purpose, the static state device 300 may comprise an antenna arrangement, not shown, configured to capture electromagnetic energy transmitted from the updating device 400. The receiver 306 may comprise the antenna arrangement.

The transmitter 402 of the updating device 400 and the receiver 306 of the static state display 300 may be configured to communicate via short range communication.

The updating device 400 may comprise an antenna arrangement, not shown, configured to transmit electromagnetic energy to the static state display 300. The transmitter 402 may comprise the antenna arrangement.

The short range communication may be wireless.

The short range communication may comprise INSTEON, IrDA, Wireless USB, Bluetooth, Bluetooth Low Energy, Wireless Local Area Network (WLAN) IEEE 802.x, Radio Frequency Identification (RFID), Near Field Communication (NFC), FeliCa, ANT+, Z-Wave, ZigBee, Infrared communication, or ultrasound. These wireless technologies have been developed for short distance communication, typically a few centimeters to several meters. These technologies are commonly referred to as short range communication technologies. If the short range communication is by BAN (Body Area Network) it is further possible to be close to certain that it is the associated user that operates the updating device. More specifically, BAN technology may be used as a mean to determine if the updating device 400 is used by an authorized user, i.e. by connecting a wearable device such as a smart watch or a smart bracelet being associated with a specific user. Improved safety may thereby be achieved.

The short range communication may be via a wired connection, such as an electrical cable. The wired connection may be a USB connection formed between the static state display and the updating device.

An audio jack of the updating device may further be used to transfer energy to the static state display.

The security key may also be referred to as a private security key.

The static state display may thereby be updated by sending energy using the short range communication, e.g. by NFC, Wi-Fi or other means. The powering of the static state display may for example be achieved by keeping the updating device within a short range from the static state display. Thus, harvesting using different techniques such as NFC itself, radio signal harvesting or magnetic field induction such as wireless charging may be used. The harvested energy may power the receiver of the static state display such that the update data may be received.

An amount of the energy harvested by the static state display may thereafter be utilized to update the display. The update may comprise updating the image content of the display.

The static state display may comprise a rechargeable battery, such as a Lithium-ion battery, or a capacitor having a capacity to store the harvested energy.

The person skilled in the art realizes that the short range may depend on the technology used for the short range communication. Typically, wireless technologies developed for short distance communication are suitable for efficient communication within a few centimeters to several meters.

In contrast, signals in medium range wireless communication travel up to 100 meters or so, while signals in wide area wireless communication can travel from several kilometers to several thousand kilometers.

The static state display 300 may thereafter statically display an update pertaining to the update data forever or until the next update.

The sending 110 of the data may be performed by sending a single updating message comprising the security key and the update data pertaining to an update to be displayed by the static state display.

The sending 108 of the data may be performed by sending a plurality of messages.

A first message of the plurality of messages comprises the security key and wherein the update data pertaining to an update is sent as one or more messages.

The method 100 may further comprise updating the database of the static state display 300 by sending 108 database updating data from a database updating device 500 to the static state display 300, see FIGS. 1 and 2, wherein the database updating data comprises a master key and one or more database entries. The method 100 further allows authenticating 110 the updating data sent by the database updating device 500 by comparing the master key with a reference master key stored in the database; upon successful authentication updating 112 the database with the one or more database entries.

Correspondingly, the system 200 may further comprise a database updating device 500. The data base updating device 500 comprising: a transmitter 502 configured to send 108 database updating data, from the database updating device 500 to the static state display 300, the database updating data comprising a master key and one or more database entries. The receiver 306 of the static state display 300 may further be configured to receive database updating data from the database updating device 500. The circuitry 308 of the static state display 300 may further configured to authenticate 110 the updating data sent by the database updating device by comparing the master key with a reference master key stored in the database. Upon successful authentication, the database with the one or more database entries may be updated 112.

The master key allows for efficient management of reference security keys stored in the database. An improved security is thereby obtained as valid security keys for updating the static state display may be brought up-to-date.

The transmitter 502 of the database updating device 500 may further be configured to send 504 authorization data comprising a security key to the updating device 400. The updating device 400 may further comprise: a receiver 405 configured to receive the authorization data from the database updating device 500, and a memory 406 storing the authorization data comprising a security key received from the database updating device 500. Authorization may thereby be given to the updating device 400 by the database updating device 500.

An efficient distribution of security keys to appropriate updating devices may thereby be achieved. An updating device which is associated with a user which is or should be authorized to update the content of the static state display may thereby efficiently receive a certain security key.

The updating device 400 may store the authorization data on the memory 406.

The updating device 400 may further comprise a processor 408 configured to run an operating system. The processor 408 may further be part of a circuitry 410 arranged to control the transmitter 402, the memory 406 and/or the receiver 405 of the updating device 400.

The database updating device 500 may further comprise a processor 506 configured to run an operating system. The processor 506 may further be part of a circuitry 508 arranged to control the transmitter 502 and a memory 510 storing the authorization data.

The circuitry 410 and/or 508 may be hardware and/or software implemented.

FIG. 3 illustrates a system 200 comprising a static state display 300 and a plurality of updating devices 600, 700, 800. Each of the updating devices may be arranged as the updating device 400 described above.

The static state display 300 may be divided into a plurality of sub-regions, here exemplified by the sub-regions 310, 312, 314. Each of the one or more reference security keys described above may further be assigned to the one or more of the plurality of sub-regions 310, 312, 314, wherein the data further comprises update data pertaining to at least one of the sub-regions 310, 312, 314 of the static state display 300.

A database updating device 500 may further be configured to send 900 authorization data comprising different security key to the respective updating devices 600, 700, 800. Each of the security keys sent to the respective updating devices 600, 700, 800 may thereby correspond to one reference security key assigned to one of the plurality of respective sub-regions 310, 312, 314.

A sent security key may alternatively correspond to a reference security key, assigned to more than one of the plurality of sub-regions.

The database updating device may send the authorization data by a cellular wide range network 1000.

The cellular wide range network 1000 may be a local area network, a LAN, an internet, or a telecommunication network. The cellular wide range network may e.g. be based on standards such as LTE, GSM, UMTS, and WCDMA. In short the standards referred to are:

LTE (Long-Term Evolution) commonly marketed as 4G LTE (fourth generation LTE) is a standard for wireless communication of high-speed data for mobile phones and data terminals. Different LTE frequencies and bands used in different countries will mean that only multi-band phones will be able to use LTE in all countries where it is supported.

GSM (Global System for Mobile Communications, originally Groupe Spécial Mobile), is a standard developed by the European Telecommunications Standards Institute (ETSI) to describe the protocols for second-generation (2G) digital cellular networks used by mobile phones.

UMTS (Universal Mobile Telecommunications System) is a third generation mobile cellular system for networks based on the GSM standard. Developed and maintained by the 3GPP (3rd Generation Partnership Project). UMTS uses wideband code division multiple access (W-CDMA) radio access technology to offer greater spectral efficiency and bandwidth to mobile network operators.

The database updating device may alternatively send the authorization data by short range communication.

An update of the respective sub-regions 310, 312, 314 of the static state display 300 may thereby be allowed by use of the respective security key. As a non-limiting example the updating device 600 may, using the method 100, update the update displayed in the sub-region 310 of the static state display 300. The update data sent 102 pertains in this example to text elements. More specifically, an image 604 comprising the wording “Status”, shown on a display 602 of the updating device 600, may be transferred from the updating device 600 to the static state display 300 by the method 100 such that a corresponding update 302 is displayed on the static state display 300. As only a portion of the static state display 300 is updated a reduced amount of data may be sent from the updating device 600 to the static state display 300. Similarly, an image 704 shown on the display 702 of the updating device 700 may be transferred and displayed on the static state device 300 by the method 100. Thus, an update 302 on the static state display 300 comprising the text and number “ID 1234”, may be updated for the sub-region 312 of the static state display 300. Likewise, the graphical element 804 displayed 802 on the updating device 700 may be sent to the static state displayed to update the update 302 in the sub-region 314.

Thus, the above described division of the static state display into a plurality of sub-regions 310, 312, 314 allows for separate administration of different sub-regions. The method 100 thereby allows for improved management of the content displayed in the static state display.

The division of the static state display into sub-regions allows for a distributed access to the different sub-regions. Access for users is may thereby be based upon what sub-region or sub-regions they are allowed to update. As a non-limiting example, the static state display may be arranged in a hospital, e.g. placed on a patient bed. A doctor provided with the updating device 600 may using the method 100 thereby update the sub-region 310 to indicate an updated “Status” of a patient. A hospital administrator may be provided with the updating device 700 update the sub-region 312 to indicate an identification “ID 1234” of the patient. Finally, a nurse or the patient provided with the updating device 800 may update a perceived health status in the sub-region 314. This ensures improved patient safety as authorization is only given to the authorized person having access to the respective sub-regions of the static state display. In other words, the method 100 and system 200 described above allows for a restriction of who or what group of users that are allowed to update the update content of the static state display. It may thereby be ensured that the information displayed, in each sub-regions, of the static state display was updated by the to the sub-region authorized user.

Two or more updating devices may comprise the authorization data comprising the same secure key.

The master key may allow for managing of the sub-regions of the static state display.

The master key may thereby allow for assignment of new users by providing secure keys to different updating devices.

This static state display may also for instance be used in semi-public spaces such as in hotels for rooms or at restaurants for menus.

An example of a static state display is electronic paper, also referred to as e-paper, which refers to displays that mimic the appearance of ordinary ink on paper. Unlike conventional backlit flat panel displays, such as LCD screens, that emit light, the electronic paper displays may be arranged to provide optical contrast by reflecting light, much similar to the ink on a paper. To this end, the electronic paper may show static text and/or images indefinitely without electricity being provided to the electronic paper. In other words, an electronic paper display consumes power only when the display content is changed or updated.

As an example, the static state display may comprise an electrophoretic arrangement, in which light scattering particles, typically, one micrometer in diameter are dispersed in an oil comprising a dark-colored dye together with surfactants and charging agents that cause the particles to take on an electric charge. This mixture is placed between two parallel, conductive plates separated by a gap such that when an electrical potential is applied across the two plates, the light scattering particles migrate electrophoretically to the plate that bears the opposite charge from that on the particles. As an example, the solid state display may appear white, when the light scattering particles are located at a viewing side of the display. The solid state display may, in contrast, appear dark when the electrical potential is applied such that the light scattering particles are located at the rear side of the display and incident light is absorbed by the colored dye. The static state display may, thereby be switched between reflecting and absorbing states. By further dividing at least one of the conductive plates into a number of small elements, display pixels may be formed such that a text and/or an image may be displayed.

The skilled person realizes that other techniques may be used to provide a static state display, such microencapsulated electrophoretic display, or techniques based on electrowetting techniques or electrofluidics.

1. A method for secure updating of a static state display, the method comprising:
sending data from an updating device to the static state display, wherein the data comprises a security key and update data pertaining to an update to be displayed by the static state display;
authenticating the data sent by the updating device at the static state display by comparing the security key with one or more reference security keys stored in a database accessible by the static state display; and
upon successful authentication updating the static state display with the update.

2. The method according to claim 1, wherein the static state display is divided into a plurality of sub-regions), wherein each of the one or more reference security keys are assigned to one or more of the plurality of sub-regions, wherein the data further comprises update data pertaining to at least one of the sub-regions of the static state display.

3. The method according to claim 1, further comprising updating the database by
sending database updating data from a database updating device to the static state display, wherein the database updating data comprises a master key and one or more database entries;
authenticating the updating data sent by the database updating device by comparing the master key with a reference master key stored in the database;
upon successful authentication updating the database with the one or more database entries.

4. The method according to claim 1, wherein the sending of the data is performed by sending a single updating message comprising the security key and the update data pertaining to an update to be displayed by the static state display.

5. The method according to claim 1, wherein the sending of the data is performed by sending a plurality of messages.

6. The method according to claim 5, wherein a first message of the plurality of messages comprises the security key and wherein the update data pertaining to an update is sent as one or more messages.

7. The method according to claim 1, the method further comprising harvesting energy from the updating device to power the updating of the static state display.

8. The method according to claim 7, wherein the harvesting of energy comprises receiving, by the static state display, electromagnetic energy transmitted by the updating device.

9. A system comprising a static state display and an updating device,
the updating device comprising:
a transmitter configured to send data, from the updating device to the static state display by short range communication, the data comprising a security key and update data pertaining to an update to be displayed by the static state display;
the static state display comprising:
a receiver configured to receive by short range communication data from the updating device; and
circuitry configured to:
authenticate the data sent by the updating device by comparing the security key with one or more reference security keys stored in a database accessible by the static state display; and
upon successful authentication, update the static state display with the update.

10. The system according to claim 9, wherein the static state display further comprises a memory storing the database comprising one or more reference security keys.

11. The system according to claim 9, further comprising a database updating device, the data base updating device comprising:
a transmitter configured to send database updating data, from the database updating device to the static state display, the database updating data comprising a master key and one or more database entries;
wherein the receiver of the static state display is further configured to receive database updating data from the database updating device; and
wherein the circuitry of the static state display is further configured to authenticate the updating data sent by the database updating device by comparing the master key with a reference master key stored in the database; and
upon successful authentication updating the database with the one or more database entries.

12. The system according to claim 11, wherein the transmitter of the database updating device is further configured to send authorization data comprising a security key to the updating device, and
wherein the updating device further comprises:
a receiver configured to receive the authorization data from the database updating device, and
a memory storing the authorization data comprising a security key received from the database updating device.

13. The system according to claim 10, wherein the receiver of the static state display is configured to harvest energy transmitted by the transmitter of the updating device.
